(19) United States
(12) Patent Application Publication
(10) Pub. No.: US 2019/0367718 A1
(43) Pub. Date: Dec. 5, 2019

(54) ETHYLENE-VINYL ALCOHOL RESIN COMPOSITION, MULTILAYER STRUCTURE, MULTILAYER FILM OR SHEET, CONTAINER AND PACKAGING MATERIAL

(71) Applicant: KURARAY CO., LTD., Kurashiki-shi (JP)

(72) Inventor: Wataru HIROSE, Houston, TX (US)

(73) Assignee: KURARAY CO., LTD., Kurashiki-shi (JP)

(21) Appl. No.: 16/416,632

(22) Filed: May 20, 2019

Related U.S. Application Data
(60) Provisional application No. 62/678,345, filed on May 31, 2018.

(51) Int. Cl. C08L 29/04; B32B 27/30; B32B 27/08; C08L 77/00; C08K 5/098; B32B 27/34

(52) U.S. Cl. CPC C08L 29/04; B32B 27/306; B32B 27/08; C08L 77/00; B32B 2270/00; B32B 27/34; B32B 2307/308; B32B 2307/50; B32B 2553/00; C08K 5/098

(57) ABSTRACT

Provided is a resin composition containing an ethylene-vinyl alcohol copolymer, a polyamide and a higher fatty acid metal salt, a multilayer structure and a multilayer sheet including the resin composition, and a container and a packaging material including the multilayer sheet. It is particularly concerned with good retort resistance, good thermal stability and good orientability.

### CROSS REFERENCE TO RELATED APPLICATIONS

This application claims priority under 35 U.S.C. § 119 from U.S. Provisional Application Ser. No. 62/678,345 (filed 31 May 2018), the disclosure of which is incorporated by reference herein for all purposes as if fully set forth.

### FIELD OF THE INVENTION

The present invention relates to a resin composition containing an ethylene-vinyl alcohol copolymer, a polyamide and a higher fatty acid metal salt, a multilayer structure and a multilayer film or sheet including the resin composition, and a container and a packaging material including the multilayer film or sheet. It is particularly concerned with materials displaying good retort resistance, good thermal stability and good orientability.

### BACKGROUND OF THE INVENTION

Ethylene-vinyl alcohol copolymers (“EVOH”) are useful polymeric materials that are superior in barrier properties against various types of gases such as oxygen, oil resistance, antistatic properties, mechanical strength and the like; therefore, EVOHs are formed into films, sheets and the like, and widely used as various types of packaging materials, containers, etc. In particular, laminates constituted with an EVOH layer and other thermoplastic resin layers are known to be useful as packaging materials for boiling sterilization or retort sterilization of foods.

However, when such laminates are subjected to boiling or retorting sterilization using hot water, water penetrates into the EVOH layer during the processing, leading to deterioration of mechanical properties of the EVOH layer. As a method for an improvement of the mechanical properties, blending the EVOH with a polyamide (“PA”) having superior hot water resistance has been conventionally employed (hereinafter, suitability for such boiling sterilization or retorting sterilization may be also referred to as “retort resistance”).

For further improving the retort resistance, the following methods have been developed: a method involving laminating a layer formed from a resin composition having the mass ratio of EVOH/PA of 55/45 or more and 97/3 or less as an outermost layer, and a layer formed from a thermoplastic resin having low moisture permeability as an inner layer (see JPH1080981(A)); a method involving incorporating a metal compound and/or a boric acid compound into an intermediate layer formed from a composition containing EVOH and a PA (see JPH04131237(A)); and a method involving forming an intermediate layer from a composition containing two types of EVOHs and PA (see JPH0623924(A)).

While the retort resistance of conventional resin compositions containing EVOH and PA has been improved, a crosslinking reaction may proceed between a hydroxyl group or a terminal carboxyl group of the EVOH and an amide group, a terminal amino group or a terminal carboxyl group of the PA, leading to non-uniformity of a resin viscosity and resulting in significant generation of burnt deposits within an extruder, a screw and a die during melt molding over a long time period. In order to solve this bad thermal stability issue, much work has been done like described in JP2001200123A, US2016/0221314A1, US2017/0267851A1 and US2018/0044502A1.

Specifically, in US2018/0044502A1, a basic metal salt is added to a resin composition comprising an EVOH, PA and drying agent to improve retort resistance. The disclosed drying agent is a hydrate-forming metal salt, typically an alkali or alkaline earth metal-containing compound, which can trap water coming into a layer of the resin composition during treatment with hot water. It is considered necessary in US2018/0044502A1 to use the drying agent in relatively large amounts (the mass ratio of drying agent/EVOH and PA blend is greater than 1/99, and preferably greater than 5/95) for the indicated performance advantage. The use of such large amounts of drying agent, however, can lead to very high alkali metal and/or alkaline earth metal concentrations in the resin composition, as well as very high acidic counterion concentrations, which can ultimately lead to poor thermal stability of films and other articles made from the resin composition.

In another aspect, resin compositions containing EVOH and PA blend (“EVOH+PA”) sometimes is processed for PA/“EVOH+PA”/PA co-extrusion and co-orientation film. Because EVOH+PA has lower orientability than PA, co-orientation process may fail and cause film breakage. Even if co-orientation process works well, PA/“EVOH+PA”/PA film may not show enough retort/boil resistance because of interface crack between EVOH matrix and PA domain.

It is still difficult to have the resin composition which shows good retort resistance, good thermal stability and good orientability at same time.

### SUMMARY OF THE INVENTION

The present invention was made to provide the resin composition which shows excellent boil/retort resistance, thermal stability and orientability.

It has now been found that adding a certain specified amount of a higher fatty acid metal salt to a resin composition containing EVOH and PA is effective to improve not only thermal stability of the resin composition but also orientability of the films containing the resin composition layer. Further, it has been found that resin compositions in accordance with the present invention have a higher melt flow rate (MFR) at 40 min holding than at 20 min holding when measured at 230° C., which provides excellent long-run stability during the film making process and allows industrial use of the present resin composition.

In accordance with the present invention, a resin composition is provided which comprises:

(A) an ethylene-vinyl alcohol copolymer having an ethylene content of from about 20 mol % to about 60 mol %;

(B) a polyamide; and

(C) a higher fatty acid metal salt;

wherein:
(i) the mass ratio (A/B) of the ethylene-vinyl alcohol copolymer (A) to the polyamide (B) is from about 80/20 to about 95/5,
(ii) the content of the higher fatty acid metal salt (C) with respect to the resin content (A+B) in terms of metal element equivalent is from about 100 ppm to about 250 ppm, and
(iii) the resin composition has a higher melt flow rate (MFR) at 40 min holding than 20 min holding measured at 230° C.

In another embodiment, the ethylene-vinyl alcohol copolymer (A) has a degree of saponification of about 99 mol % or greater.

In another embodiment, the ethylene-vinyl alcohol copolymer has an ethylene content of form about 20 mol % to about 50 mol %.

In another embodiment, the higher fatty acid metal salt is Mg stearate.

In another embodiment, the resin composition contains about 1000 ppm or less total of alkali metal and alkaline earth metal in terms of metal element equivalent.

In another embodiment, the resin composition has from about 1.1 times to about 3 times higher melt flow rate (MFR) at 40 min holding than MFR at 20 min holding measured at 230° C.

According to another aspect of the present invention, a multilayer film or sheet is provided that includes a barrier layer formed from the resin composition. In one embodiment, the multilayer film or sheet further includes PA layer.

According to another aspect, a container and/or a packaging material is provided that includes a multilayer film or sheet.

These and other embodiments, features and advantages of the present invention will be more readily understood by those of ordinary skill in the art from a reading of the following detailed description.

### DETAILED DESCRIPTION

The present invention relates to a resin composition containing an ethylene-vinyl alcohol copolymer, a polyamide, and a higher fatty acid metal salt, a multilayer structure and a multilayer film or sheet including the resin composition, and a container and a packaging material including the multilayer film or sheet. It is particularly concerned with good retort resistance, good thermal stability and good orientability. Further details are provided below.

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a mass or weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 mol % of a comonomer”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### Resin Composition

The resin composition in accordance with the present invention comprises (A) EVOH, (B) PA and (C) a higher fatty acid metal salt. The resin composition may contain an optional component such as a boron compound, a conjugated polyene compound, an acetic acid compound and a phosphorus compound, within a range not leading to impairment of the effects of the present invention. The total alkali metal and alkaline earth metal content should also be about 1000 ppm or less in terms of metal element equivalent. Hereinafter, each component will be described.

### (A) Ethylene-Vinyl Alcohol Copolymer

The EVOH is an ethylene-vinyl alcohol copolymer obtained by saponifying a copolymer of ethylene and a vinyl ester.

The EVOH desirably has, as a lower limit of ethylene unit content (a proportion of the number of ethylene units to the total number of monomer units in the EVOH), an ethylene unit content of about 20 mol % or greater, or about 22 mol % or greater, or about 24 mol % or greater. On the other hand, the EVOH desirably has, as an upper limit of ethylene unit content, an ethylene unit content of about 60 mol % or less, or about 55 mol % or less, or about 50 mol % or less. The EVOH having an ethylene unit content of no less than the lower limit gives a crosslinked product an excellent oxygen barrier properties in high humidity and gives excellent melt moldability. In addition, the EVOH having an ethylene unit content of no greater than the upper limit gives excellent oxygen barrier properties.

The EVOH typically has, as a lower limit of degree of saponification (a proportion of the number of vinyl alcohol units to the total number of the vinyl alcohol units and vinyl ester units in the EVOH), a degree of saponification of about 80 mol % or greater, or about 95 mol % or greater, or about 99 mol % or greater. On the other hand, the EVOH typically has, as an upper limit of degree of saponification, a degree of saponification of (substantially) 100 mol %, or about 99.99 mol % or less. The EVOH having a degree of saponification of no less than the lower limit gives excellent oxygen barrier properties and thermal stability.

A method of preparing the ethylene-vinyl alcohol copolymer is not particularly limited, and may include well-known preparing methods. For example, in a general method, an ethylene-vinyl ester copolymer obtained by copolymerizing ethylene and vinyl ester monomer is saponified under the presence of a saponification catalyst, in an organic solvent including alcohol.

Examples of the vinyl ester monomer may include vinyl formate, vinyl acetate, vinyl propionate, vinyl butyrate, vinyl isobutyrate, vinyl pivalate, vinyl versatate, vinyl caproate, vinyl caprylate, vinyl laurate, vinyl palmitate, vinyl stearate, vinyl oleate, and vinyl benzoate. Particularly, vinyl acetate is preferable.

A method of copolymerizing ethylene and vinyl ester monomer may include well-known methods such as solution polymerization, bulk polymerization, suspension polymerization, and emulsion polymerization. As a polymerization initiator, an azo-based initiator, peroxide-based initiator, redox-based initiator, and the like may be properly selected according to a polymerization method. At this time, the copolymerization may be performed under presence of thiol compounds such as thioacetic acid and mercaptopropionic acid, or other chain-transfer agents.

As a saponification reaction, alcoholysis, hydrolysis, and the like, which uses a well-known alkali catalyst or acidic catalyst as a saponification catalyst in an organic solvent, may be adopted. In particular, a saponification reaction using a caustic soda catalyst with methanol as a solvent is simple and easy, and thus, most preferable.

The EVOH used in the EVOH resin composition may be a combination of two or more different types of EVOH. For example, the EVOH can be composed of a mixture of two or more types of EVOH that are different in ethylene unit content, with the combination having an ethylene content that is calculated as an average value from a mixed mass ratio. In this case, the difference between two types of EVOH that have different ethylene unit contents is typically about 30 mol % or less, or about 20 mol % or less, or about 15 mol % or less.

Similarly, the EVOH can be composed of a mixture of two or more types of EVOH that are different in degree of saponification, with the combination having a degree of saponification that is calculated as an average value from a mixed mass ratio. In this case, the difference in degree of saponification is typically about 7% or less, or about 5% or less

The ethylene unit content and the degree of saponification of the EVOH can be determined by nuclear magnetic resonance (NMR) analysis by conventional methods as recognized by one or of ordinary skill in the relevant art.

The EVOH typically has, as a lower limit of a melt flow rate (a measured value at a temperature of 190° C. or 210° C. and a load of 2160 g in accordance with JIS K 7210), a melt flow rate of about 0.1 g/10 min or more, or about 0.5 g/10 min or more, or about 1 g/10 min or more, or about 3 g/10 min or more. On the other hand, the EVOH typically has, as an upper limit of a melt flow rate, a melt flow rate of about 200 g/10 min or less, or about 50 g/10 min or less, or about 30 g/10 min or less, or about 15 g/10 min or less, or about 10 g/10 min or less. The EVOH having a melt flow rate value in the above range improves melt kneadability and melt moldability of a resultant resin composition.

A modified EVOH can also be used. For example, a modified EVOH can have at least one structural unit selected from, for example, structural units (I) and (II) shown below.

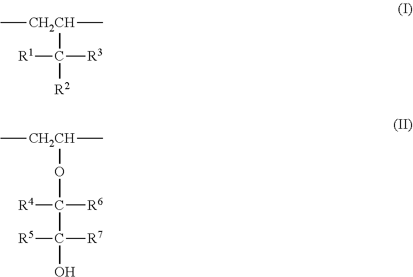

When present, such the structural unit are present at a ratio of from about 0.5 mol % to about 30 mol % based on the total structural units. Such a modified EVOH may improve flexibility and moldability of a resin or a resin composition, the interlayer adhesion, stretchability and thermoformability of the inner liner.

Each of R1, R2 and R3 in the above formula (I) independently represents a hydrogen atom, an aliphatic hydrocarbon group having 1 to 10 carbon atoms, an alicyclic hydrocarbon group having 3 to 10 carbon atoms, an aromatic hydrocarbon group having 6 to 10 carbon atoms, or a hydroxy group. Also, one pair of R1, R2 or R3 may be combined together (excluding a pair of R1, R2 or R3 in which both of them are hydrogen atoms). Further, the aliphatic hydrocarbon group having 1 to 10 carbon atoms, the alicyclic hydrocarbon group having 3 to 10 carbon atoms, or the aromatic hydrocarbon group having 6 to 10 carbon atoms may have the hydroxy group, a carboxy group or a halogen atom. On the other hand, each of R4, R5, R6 and R7 in the above formula (II) independently represents the hydrogen atom, the aliphatic hydrocarbon group having 1 to 10 carbon atoms, the alicyclic hydrocarbon group having 3 to 10 carbon atoms, the aromatic hydrocarbon group having 6 to 10 carbon atoms, or the hydroxy group. R4 and R5, or R6 and R7 may be combined together (excluding when both R4 and R5 or both R6 and R7 are hydrogen atoms). Also, the aliphatic hydrocarbon group having 1 to 10 carbon atoms, the alicyclic hydrocarbon group having 3 to 10-carbon atoms, or the aromatic hydrocarbon group having 6 to 10 carbon atoms may have the hydroxy group, an alkoxy group, the carboxy group or the halogen atom.

In another example, the following modified EVOH can be used as the EVOH, wherein the modified EVOH copolymer is represented by a following formula (III), contents (mol %) of a, b, and c based on the total monomer units that satisfy following formula (1) through (3), and a degree of saponification (DS) defined by a following formula (4) is not less than about 90 mol %.

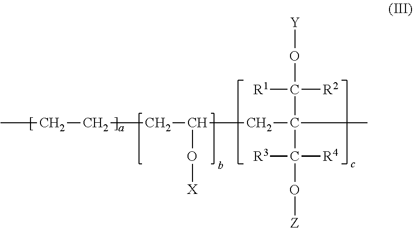

18≤a≤55 (1)

0.01≤c≤20 (2)

[100−(a+c)]×0.9≤b≤[100−(a+c)] (3)

DS=[(Total Number of Moles of Hydrogen Atoms in X, Y, and Z)/(Total Number of Moles of X, Y, and Z)]*100 (4)

In the formula (III), each of R1, R2, R3, and R4 independently denotes a hydrogen atom or an alkyl group having a carbon number of from 1 to 10, and the alkyl group may include a hydroxyl group, an alkoxy group, or a halogen atom. Each of X, Y, and Z independently denotes a hydrogen atom, a formyl group, or an alkanoyl group having a carbon number of from 2 to 10.

The EVOH may also contain, as a copolymer unit, a small amount of another monomer unit other than the ethylene unit and the vinyl alcohol unit within a range not to inhibit the purpose of the present invention. Examples of such a monomer include α-olefins such as propylene, 1-butene, isobutene, 4-methyl-1-pentene, 1-hexene, and 1-octene; unsaturated carboxylic acids such as itaconic acid, methacrylic acid, acrylic acid, and maleic acid, salts thereof, partial or complete esters thereof, nitriles thereof, amides thereof, and anhydrides thereof, vinylsilane compounds such as vinyltrimethoxysilane, vinyltriethoxysilane, vinyltri(2-methoxyethoxy)silane, and γ-methacryloxypropyltrimethoxysilane; unsaturated sulfonic acids or salts thereof; unsaturated thiols; and vinylpyrrolidones.

### (B) Polyamide

The PA is a resin that includes an amide linkage, and is typically obtained by ring-opening polymerization of a lactam having a 3 or more-membered ring; polycondensation of a polymerizable ω-amino acid; polycondensation of a dibasic acid and a diamine; and the like.

In the PA, a substituted aliphatic diamine such as 2,2,4- and 2,4,4-trimethylhexamethylenediamines, an aromatic amine such as methylbenzylamine and meta-xylylenediamine, or the like may be used as the diamine, and a modification of a polyamide with the amine may be made. Furthermore, a substituted aliphatic carboxylic acid such as 2,2,4- and 2,4,4-trimethyladipic acids, an alicyclic dicarboxylic acid such as 1,4-cyclohexanedicarboxylic acid, an aromatic dicarboxylic acid such as phthalic acid, xylylenedicarboxylic acid, alkyl-substituted terephthalic acid, alkyl-substituted isophthalic acid and naphthalenedicarboxylic acid, or the like may be used as the dicarboxylic acid, and a modification of a polyamide with the dicarboxylic acid may be made.

Examples of potentially suitable PAs include polycaproamide (nylon 6), poly-ω-aminoheptanoic acid (nylon 7), poly-ω-aminononanoic acid (nylon 9), polyundecanamide (nylon 11), polylauryllactam (nylon 12), polyethylenediamine adipamide (nylon 26), polytetramethylene adipamide (nylon 46), polyhexamethylene adipamide (nylon 66), polyhexamethylene sebacamide (nylon 610), polyhexamethylene dodecamide (nylon 612), polyoctamethylene adipamide (nylon 86), polydecamethylene adipamide (nylon 106), caprolactam/lauryllactam copolymers (nylon 6/12), caprolactam/ω-aminononanoic acid copolymers (nylon 6/9), caprolactam/hexamethylenediammonium adipate copolymers (nylon 6/66), lauryllactam/hexamethylenediammonium adipate copolymers (nylon 12/66), hexamethylenediammonium adipate/hexamethylenediammonium sebacate copolymers (nylon 66/610). ethylene diammonium adipate/hexamethylenediammonium adipate copolymers (nylon 26/66), caprolactam/hexamethylenediammonium adipate/hexamethylenediammonium sebacate copolymers (nylon 6/66/610), polyhexamethylene isophthalamide (nylon 6I), polyhexamethylene terephthalamide (nylon 6T), hexamethylene isophthalamide/terephthalamide copolymers (nylon 6I/6T), and the like. These PAs may be used alone or as a mixture of two or more types thereof.

Among these PAs, polycaproamide (nylon 6) and caprolactam/lauryllactam copolymers (nylon 6/12) are preferred. The ratio of the nylon 6 unit and the nylon 12 unit is not particularly limited, and the percentage content of the nylon 12 unit is preferably about 5% by mass or greater and about 60% by mass or less, or about 50% by mass or less.

The PA typically has, as a lower limit of a melt flow rate (a measured value at a temperature of 230° C. and a load of 2160 g in accordance with JIS K 7210), a melt flow rate of about 0.1 g/10 min or more, or about 0.5 g/10 min or more, or about 1 g/10 min or more, or about 3 g/10 min or more. On the other hand, the PA typically has, as an upper limit of a melt flow rate, a melt flow rate of about 200 g/10 min or less, or about 50 g/10 min or less, or about 30 g/10 min or less, or about 15 g/10 min or less, or about 10 g/10 min or less. PA having a melt flow rate value in the above range improves melt kneadability and melt moldability of a resultant resin composition.

### Higher Fatty Acid Metal Salt (C)

The resin composition contains the higher fatty acid metal salt (C). Due to containing the higher fatty acid metal salt (C), the resin composition can inhibit the occurrence of gelation in an operation over a long time period.

The metal element in the higher fatty acid metal salt (C) is not particularly limited. In light of inhibitory effects on the gelation, the metal element is exemplified by metal elements that give a divalent metal salt, such as magnesium, calcium, zinc and copper. Of these, magnesium, calcium, zinc or a combination thereof is preferred.

The higher fatty acid that gives the carboxylic acid anion having 12 to 26 carbon atoms. An anion in the higher fatty acid metal salt (C) is not particularly limited as long as it is a higher fatty acid anion, and is exemplified by an anion of higher fatty acid such as stearic acid, dimethyldithiocarbamic acid, palmitic acid, 2-ethylhexanoic acid, neodecanoic acid, linoleic acid, tallic acid, oleic acid, capric acid, naphthenic acid or sorbic acid, and the like. Of these, stearic acid and oleic acid or a combination thereof is preferred.

### Resin Composition—Proportions and Properties

In regard to the ratio of the EVOH (A) and the PA (B) contained in the resin composition, the lower limit of the mass ratio of the EVOH (A) to the PA (B) is about 80/20, or about 85/15 Moreover, the upper limit of the mass ratio is about 95/5, or about 90/10. When the mass ratio is less than the lower limit, characteristics such as gas barrier properties against various types of gases and oil resistance each inherently exhibited by the EVOH (A) may be deteriorated. To the contrary, when the mass ratio is greater than the upper limit, the retort resistance of the resin composition may be deteriorated.

The total mass of the EVOH (A) and the PA (B) with respect to the resin content in the resin composition is preferably about 80% by mass or greater, or about 90% by mass or greater, or about 95% by mass or greater, or substantially 100% by mass (or 100% by mass).

The lower limit of the content of the higher fatty acid metal salt (C) with respect to the resin content (A+B) in terms of metal element equivalent is about 100 ppm, or about 110 ppm, or about 120 ppm. The upper limit of the content of the higher fatty acid metal salt (C) with respect to the resin content (A+B) in terms of metal element equivalent is about 250 ppm, or about 225 ppm, or about 200 ppm. When the content is less than the lower limit, the resin composition may exhibit insufficient inhibitory effects on the gelation in an operation over a long time period. Furthermore, the resin composition may show insufficient elongation properties. When the content is greater than the upper limit, the resin composition may cause crosslinking reaction, leading to insufficient long run stability. The content of the higher fatty acid metal salt (C) in the resin composition as referred to herein means a proportion with respect to the resin content (A+B) in the resin composition, i.e. a proportion by mass in terms of metal element equivalent with respect to the total mass of the resin component (A+B), and more specifically, a proportion with respect to the resin content (A+B) in a dried resin composition. In the resin composition, the higher fatty acid metal salt (C) may be used either alone, or in combination of two or more types thereof.

The resin composition typically has, as a lower limit of a melt flow rate (a measured value at a temperature of 230° C. and a load of 2160 g in accordance with JIS K 7210), a melt flow rate of about 0.1 g/10 min or more, or about 0.5 g/10 min or more, or about 1 g/10 min or more, or about 3 g/10 min or more. On the other hand, the PA typically has, as an upper limit of a melt flow rate, a melt flow rate of about 200 g/10 min or less, or about 50 g/10 min or less, or about 30 g/10 min or less, or about 15 g/10 min or less, or about 10 g/10 min or less. The resin composition having a melt flow rate value in the above range improves melt kneadability and melt moldability of a resultant resin composition.

The resin composition has a higher melt flow rate (MFR) at 40 min holding than 20 min holding measured at 230° C. The resin composition satisfying this parameter shows excellent long run stability. A lower limit of MFR at 40 min holding/MFR at 20 min holding is preferably about 1.1, or about 1.3, or about 1.5. A higher limit of MFR at 40 min holding/MFR at 20 min holding is preferably about 3.0, or about 2.5, or about 2.0. The MFR at 40 min holding/MFR at 20 min holding can be affected by EVOH structures such as ethylene content, molecular weight, saponification degree, modification degree, the ratio of the EVOH (A) and the PA (B) and the contents of the higher fatty acid metal salt.

### Optional Components

### Boron Compound

The boron compound inhibits gelation in the melt molding, and additionally inhibits a torque fluctuation of an extrusion molding machine or the like, i.e., a variation of a viscosity during heating. Examples of the boron compound include boric acids such as orthoboric acid, metaboric acid and tetraboric acid; boric acid esters such as triethyl borate and trimethyl borate; boric acid salts such as alkali metal salts and alkaline earth metal salts of the aforementioned boric acids, and borax; boron hydrides; and the like. Of these, boric acids are preferred, and orthoboric acid is more preferred.

When present, the lower limit of the content of the boron compound in the resin composition is preferably about 100 ppm, and the upper limit of the content of the boron compound is preferably about 5,000 ppm. When the content of the boron compound is less than the lower limit, a torque fluctuation of an extrusion molding machine or the like may not be sufficiently inhibited. On the other hand, when the content of the boron compound is greater than the upper limit, gelation is likely to occur during the melt molding, and consequently the appearance of the formed article may be deteriorated.

### Conjugated Polyene Compound

The conjugated polyene compound inhibits oxidative degradation in melt molding. The “conjugated polyene compound” as referred to herein means a compound having a conjugated double bond, as generally referred to, i.e., a compound having two or more carbon-carbon double bonds and a structure in which a carbon-carbon double bond and a carbon-carbon single bond are alternately connected. The conjugated polyene compound may be a conjugated diene including two double bonds involved in the conjugation, a conjugated triene including three double bonds involved in the conjugation, or a conjugated polyene including four or more double bonds involved in the conjugation. In addition, the conjugated double bond may be present in a multiple number in a single molecule without being conjugated with one another. For example, compounds having three conjugated triene structures in a single molecule, such as tung oil, may also be included in the conjugated polyene compound.

The conjugated polyene compound preferably has 7 or less conjugated double bonds. When the resin composition contains a conjugated polyene compound having 8 or more conjugated double bonds, the coloring of the formed article is highly likely to occur.

The conjugated polyene compound may be used either alone, or two or more types thereof may be used in combination. The conjugated polyene compound has preferably 4 to 30 carbon atoms, or 4 to 10 carbon atoms. The conjugated polyene compound is preferably a sorbic acid ester, myrcene or a combination thereof.

The molecular weight of the conjugated polyene compound is preferably about 1,000 or less. When the molecular weight of the conjugated polyene compound is greater than 1,000, the state of dispersion of the conjugated polyene compound in the EVOH (A) may be inferior, and the appearance after the melt molding may be unfavorable.

When present, the lower limit of the content of the conjugated polyene compound in the resin composition is preferably about 0.01 ppm, and the upper limit of the content is preferably about 1,000 ppm. When the content of the conjugated polyene compound is less than the lower limit, the inhibitory effects on oxidative degradation in the melt molding may not be sufficiently achieved. On the other hand, when the content of the conjugated polyene compound is greater than the upper limit, the gelation of the resin composition may be facilitated.

JPH0971620 (A) discloses that when the conjugated polyene compound is added in a step following the polymerization step, a resin composition containing less gelled matter generated in molding can be obtained.

### Acetic Acid

Acetic acid prevents the coloring of the formed article, and additionally inhibits gelation during melt molding.

When present, the lower limit of the content of acetic acid in the resin composition is preferably about 50 ppm, or about 100 ppm, or about 150 ppm, or about 200 ppm, and the upper limit of the content of acetic acid is preferably about 1,000 ppm, or about 500 ppm, or about 400 ppm. When the content of acetic acid is less than the lower limit, sufficient coloring preventive effects may not be achieved, and yellowing of the formed article may occur. On the other hand, the content of acetic acid is greater than the upper limit, gelation is likely to occur in the melt molding, in particular, in melt molding over a long time period, and consequently the appearance of the formed article may be deteriorated.

### Phosphorus Compound

The phosphorus compound inhibits the coloring and the generation of defects such as streaks and fish eyes, and additionally improves the long-run workability. Examples of the phosphorus compound include various types of phosphoric acids such as phosphoric acid and phosphorous acid, phosphates, and the like. The phosphate may be in any form of a monobasic phosphate salt, a dibasic phosphate salt and a tribasic phosphate salt. In addition, the cationic species contained in the phosphate is not particularly limited, and alkali metal salts and alkaline earth metal salts are preferred. Of these, sodium dihydrogen phosphate, potassium dihydrogen phosphate, disodium hydrogen phosphate and dipotassium hydrogen phosphate are more preferred, and sodium dihydrogen phosphate and dipotassium hydrogen phosphate are still more preferred.

When present, the lower limit of the content of the phosphorus compound in the resin composition is preferably 1 ppm, and the upper limit of the content of the phosphorus compound is preferably 200 ppm. When the content of the phosphorus compound is less than the lower limit, or when the content of the phosphorus compound is greater than the upper limit, the thermal stability may be deteriorated, and the coloring and the occurrence of gelation are likely to occur in the melt molding over a long time period.

### Other Optional Components

The resin composition may contain other optional component, within a range not leading to impairment of the effects of the present invention. The other optional component is exemplified by an alkali metal, an alkali earth metal (not a higher fatty acid salt), an antioxidant, an UV absorbent, a plasticizer, an antistatic agent, a lubricant, a colorant, a filler, a heat stabilizer, other resin, and the like. The resin composition may contain two or more types of these optional components, and when present the total content of the optional component is preferably about 1% by mass or less with respect to the resin composition.

Examples of the alkali metal include lithium, sodium, potassium, and the like. When present, the lower limit of the content of the alkali metal in the resin composition is preferably about 20 ppm, or about 50 ppm, and the upper limit of the content is preferably about 1,000 ppm, or about 500 ppm, in terms of metal element equivalent.

Overall, the total content of alkali metal and alkaline earth metal combined should be limited and not exceed about 1000 ppm, or about 750 ppm, or about 500 ppm, in terms of metal element equivalent.

It is to be noted that in order to inhibit the gelation, for example, a hindered phenol compound, a hindered amine compound, a hydrotalcite compound or the like may be added. These may be used either alone, or two or more types thereof may be used in combination. When present, the amount of the compound added to inhibit the gelation is typically about 0.01% by mass or greater, and about 1% by mass or less.

### Production Method of the Resin Composition

The production method of the resin composition according to the embodiment of the present invention is not particularly limited, and well-known apparatus and methods may be applied.

In one embodiment, pellets of the EVOH (A) and pellets of the PA (B) are first produced. Thereafter, the pellets of the EVOH (A) and the pellets of the PA (B) and powder of the higher fatty acid metal salt (plus any optional components) are dry-blended, and thereafter melt-extruded using a single screw extruder, a twin-screw extruder, or the like to achieve pelletization, whereby the resin composition of the embodiment of the present invention are obtained.

### Multilayer Article

The resin composition according to the embodiment of the present invention can be molded into, for example, a film, a sheet, a container, other packaging material (for foods, medical drugs, etc.), and the like through melt molding. In particular, a film or sheet produced using the pelletized resin composition can prevent the whitening of a part thereof, which may matter, after the heating treatment, and therefore is suitable for use as a packaging material for a retort treatment or a packaging material for a boiling treatment. In addition, the film or sheet thus produced may be subjected to secondary processing to produce a molded article.

The film or sheet may be either single-layered or multi-layered. Preferably, for the purpose of preventing the deterioration of the gas barrier performances of the resin composition due to moisture, the film or sheet is used in the form of a multilayer structure having the film or sheet and a layer composed of a hydrophobic thermoplastic resin. More preferably, for the purpose of recovering from the retort shock which is OTR deterioration after retort treatment, the film or the sheet has polyamide layer.

The multilayer film or sheet containing polyamide layer may be uniaxially or biaxially oriented to get tough characteristic, better gas barrier characteristic, dimensional stability, and pin hole resistance.

Examples of the hydrophobic thermoplastic resin include polyolefin resins (such as polyethylene resins and polypropylene resins), grafted polyolefin resins graft-modified with an unsaturated carboxylic acid or an ester thereof, halogenated polyolefin resins, ethylene-vinyl acetate copolymer resins, ethylene-acrylic acid copolymer resins, ethylene-acrylic acid ester copolymer resins, polyester resins, polyvinyl chloride resins, polyvinylidene chloride resins, acrylic resins, polystyrene resins, vinyl ester resins, ionomers, polyester elastomers, polyurethane elastomers, aromatic or aliphatic polyketones, and the like. Among these, in light of mechanical strength and molding processability, polyolefin resins are preferred, and polyethylene resins or polypropylene resins are still more preferred.

Examples of the polyamide include polycaproamide (nylon 6), poly-ω-aminoheptanoic acid (nylon 7), poly-ω-aminononanoic acid (nylon 9), polyundecanamide (nylon 11), polylauryllactam (nylon 12), polyethylenediamine adipamide (nylon 26), polytetramethylene adipamide (nylon 46), polyhexamethylene adipamide (nylon 66), polyhexamethylene sebacamide (nylon 610), polyhexamethylene dodecamide (nylon 612), polyoctamethylene adipamide (nylon 86), polydecamethylene adipamide (nylon 106), caprolactam/lauryllactam copolymers (nylon 6/12), caprolactam/ω-aminononanoic acid copolymers (nylon 6/9), caprolactam/hexamethylenediammonium adipate copolymers (nylon 6/66), lauryllactam/hexamethylenediammonium adipate copolymers (nylon 12/66), hexamethylenediammonium adipate/hexamethylenediammonium sebacate copolymers (nylon 66/610). ethylene diammonium adipate/hexamethylenediammonium adipate copolymers (nylon 26/66), caprolactam/hexamethylenediammonium adipate/hexamethylenediammonium sebacate copolymers (nylon 6/66/610). polyhexamethylene isophthalamide (nylon 6I), polyhexamethylene terephthalamide (nylon 6T), hexamethylene isophthalamide/terephthalamide copolymers (nylon 6I/6T), and the like. Among these polyamides, polycaproamide (nylon 6) and caprolactam/lauryllactam copolymers (nylon 6/12) are preferred. The ratio of the nylon 6 unit and the nylon 12 unit is not particularly limited, and the percentage content of the nylon 12 unit is preferably about 5% by mass or greater and about 60% by mass or less, or about 50% by mass or less.

The layer configuration of the multilayer structure is exemplified by the following layer configurations, wherein: “EVOH+PA” represents a layer formed from the pelletized resin composition according to the embodiment of the present invention; “PO” represents a layer composed of a hydrophobic thermoplastic resin; “AD” represents a layer composed of the hydrophobic thermoplastic resin modified with an unsaturated carboxylic acid or a derivative thereof, and “PA” represents a layer composed of a polyamide. The layers represented from the left to right in each layer configuration below are to be provided to follow the order, from the outer side (i.e., the side nearest the external environment) to the inner side. The layer AD composed of the hydrophobic thermoplastic resin modified with the unsaturated carboxylic acid or a derivative thereof may be used as an adhesive resin layer, or an outer layer.

3 layers, PA/“EVOH+PA”/AD, PA/“EVOH+PA”/PA, AD/“EVOH+PA”/AD,
4 layers, PA/“EVOH+PA”/AD/PO, PA/“EVOH+PA”/PA/AD, AD/“EVOH+PA”/AD/PO,
5 layers, PA/“EVOH+PA”/PA/AD/PO, AD/PA/“EVOH+PA”/PA/AD, PO/AD/“EVOH+PA”/AD/PO,
6 layers, PA/“EVOH+PA”/PA/AD/PO/PO, PA/“EVOH+PA”/PA/AD/PA/AD
7 layers, PA/“EVOH+PA”/PA/AD/PA/AD/PO

In addition, a layer of a polyethylene terephthalate film, polypropylene film, material such as paper, metal foil, woven fabric, nonwoven fabric, metal cotton, wooden material, aluminum- or silica-vapor deposition film may be combined with the layer of the resin to form the multilayer structure. Especially, if the multilayer structure need a printing, a reverse printed polyethylene terephthalate film is combined with the multilayer structure.

Regarding the thickness of a multilayer article in accordance with one embodiment of the present invention, the total thickness thereof is typically from about 50 μm, or from about 75 μm, or from about 100 μm, to about 300 μm, or to about 250 μm, or to about 200 μm.

The thickness of the (each) “EVOH+PA” resin composition layer in the film is not particularly limited, but is typically from about 1 μm, or from about 2 μm, or from about 5 μm, to about 100 μm, or to about 50 μm, or to about 25 μm.

The thickness of the (each) hydrophobic resin composition layer in the film is not particularly limited, but is typically from about 10 μm, or from about 20 μm, or from about 30 μm, to about 200 μm, or to about 150 μm, or to about 100 μm.

The thickness of the (each) hydrophobic thermoplastic resin modified with an unsaturated carboxylic acid or a derivative thereof layer in the film is not particularly limited, but is typically from about 1 μm, or from about 2 μm, or from about 5 μm, to about 100 μm, or to about 50 μm, or to about 25 μm.

The thickness of the (each) polyamide resin composition layer in the film is not particularly limited, but is typically from about 1 μm, or from about 2 μm, or from about 5 μm, to about 100 μm, or to about 50 μm, or to about 25 μm.

### Container

In another embodiment of the present invention, the container is produced by thermoforming the multilayer film or sheet into a three-dimensional shape such that a recessed part is provided on the plane of the multilayer film or sheet. The container is suitably formed through the aforementioned vacuum/pressure forming process. The shape of the recessed part may be decided in accordance with the shape of the contents. In particular, as the depth of the recessed part is greater, or as the shape of the recessed part is less smooth, the improvement effect exerted by the present invention is significant since for such a shape of the recessed part, typical EVOH laminates are more likely to cause unevenness in thickness, leading to extreme slimming at corner portions and the like. In a case where the container is formed from a multilayer film having an entire layer thickness of less than about 300 μm, the effects of the invention may be exhibited more effectively at a draw ratio (S) of suitably about 0.2 or greater, or about 0.3 or greater, or about 0.4 or greater. Alternatively, in a case where the container is formed from a multilayer film or sheet having an entire layer thickness of about 300 μm or greater, the effects of the invention may be exhibited more effectively at a draw ratio (S) of suitably about 0.3 or greater, or about 0.5 or greater, or about 0.8 or greater.

The draw ratio (S) as referred to herein means a value calculated using the following equation (1):

S=(a depth of the container)/(the diameter of the largest circle inscribed in the opening of the container) (1)

In other words, the draw ratio (S) is a value obtained by dividing a value of the depth of the bottom of the recessed part of the container by a value of the diameter of the largest inscribed circle tangent to the shape of the recessed part (opening) provided on the plane of the multilayer film or sheet. The value of the diameter of the largest inscribed circle corresponds to, for example, a diameter of a circular shape when the shape of the opening of the recessed part is circular; a minor axis of an elliptical shape when the shape of the opening of the recessed part is elliptical; and a length of the shorter side of a rectangular shape when the shape of the opening of the recessed part is rectangular.

The multilayer article and container of the present invention can be a packaging material.

### EXAMPLES

Hereinafter, the present invention will be explained in detail by way of Examples and Comparative Examples, but the present invention is not limited to the following Examples. It is to be noted that production methods as well as methods of measurement, calculation and evaluation in Examples and Comparative Examples were each as described below.

### Ethylene Unit Content in and Saponification Degree of EVOH

Measurement was conducted by 1H-NMR measurement (JNM-GX-500, JEOL Ltd., Tokyo Japan) using DMSO-d6 as a solvent.

### Determination of Amount of Fatty Acid Metal Salt in Resin Composition Pellet

Into a Teflon (trademark of The Chemours Company) pressure container, 0.5 g of the resin composition pellets were charged, and 5 mL concentrated nitric acid was added thereto, whereby the resin composition pellets were decomposed at room temperature for 30 min. After a lapse of 30 min, the container was covered with a lid, a first heat treatment was carried out at 150° C. for 10 min, then a subsequent heat treatment was carried out at 180° C. for 5 min, by using a wet degradation device (“MWS-2” available from Actac Project Service Corporation), to permit degradation, and then the mixture was cooled to room temperature. The treatment liquid thus obtained was transferred to a 50-mL volumetric flask (TPX) and diluted with pure water to 50 mL. Metals contained in the solution were analyzed by using an ICP optical emission spectrophotometer (“OPTIMA4300DV” available from PerkinElmer Inc.), whereby the content of metal element from the fatty acid metal salt was determined. The fatty acid salt content was calculated from the content of metal element.

### Melt Flow Rate (MFR)

The discharging rate (g/10 minutes) of a sample was measured by a melt flow indexer (MP1200, Tinius Olsen TMC, Horsham, Pa. USA) under conditions of a temperature at 190° C. or 210° C. or 230° C. and with a load of 2160 g.

### Melt Flow Rate (MFR) at 40 Min Holding/MFR at 20 Min Holding

7 g of resin composition pellets were charged in the melt flow indexer (MP1200, Tinius Olsen TMC, Horsham, Pa. USA) set at 230° C. Discharge of melted resin composition was stopped by using plug to the orifice. After 20 minutes holding, the plug was removed and discharging rate of the sample was measured. Then, the discharge of the sample was stopped by plug. After 40 minutes holding from start, the plug was removed again and discharging rate of the sample was measured. MFR at 40 min holding/MFR at 20 min holding was calculated from these measured values.

### Long Run Stability

Long run stability of the resin composition was evaluated by gel number in a monolayer film making process. Monolayer film was continuously produced at conditions below.

Apparatus, 20 mmD single screw extruder (Labo Plastomill 15C300 manufactured by Toyo Seiki Seisaku-sho, Ltd.)

L/D: 20, Screw, full flight type

Die: 300 mm coat-hanger die

Extrusion temperature (° C.): C1 to C3=230, Die=230

Screen mesh: 50/100/50

Temperature of cooling roll: 80° C.

Screw rotation speed: 40 rpm

Drawing speed: 3.0 m/minute

Film thickness 20 μm

Defect detector: Frontier System

Detector sensitivity: Very high

Gel number was counted during film making. The long run stability was evaluated by criteria below.

A: >6 hours operation to have gel number over 800 1/m2

B: 3-6 hours operation to have gel number over 800 1/m2

C: 1-3 hours operation to have gel number over 800 l/m2

D: <1 hour operation to have gel number over 800 1/m2

### Oxygen Permeability

A 20 μm thick mono layer film obtained during first 1 hour of the long run stability test was conditioned in humidity at 20° C./65% RH. In accordance with IS014663-2, oxygen permeability of the film was measured by using an oxygen permeability measuring device (OX-Tran 2/20 produced by Modern Control) at 20° C./65% RH.

Retort Resistance and Retort Resistance after Orientation

### Production of Multilayer Article

A multilayer article having PA/“EVOH+PA”/PA (15 μm/15 μm/15 μm) layer structure was produced using the following cast co-extrusion method.

Apparatus: Feed block with three-material five-layer cast extrusion machine

Extruder A: 32D Single-screw extruder (manufactured by Research Laboratory of Plastics Technology Co., Ltd.) (Polyamide (PA) layer)

Extruder B: 20D Single-screw extruder (manufactured by Toyo Seiki Seisaku-Sho, Ltd.) (the resin composition (“EVOH+PA”) layer)

Extruder C: 20D Single-screw extruder (manufactured by Technovel Corporation) (Not used)

Rotation Speed

Extruder A: 21 rpm

Extruder B: 38 rpm

Extrusion temperature (° C.)

Extruder A: C1=235, C2=250, C3=240, H1=235, AD1=235, AD2=235

Extruder B: C1=230, C2=235, C3=235, AD=235

Die temperature: 235° C.

Cooling roll temperature: 80° C.

Drawing speed: 5 m/min

Polyamide: SF1018 produced by UBE Industries, Ltd.

For retort resistance after orientation, the multilayer article was bi-axially oriented for 2 times by 2 times by using SDR-506WK manufactured by Eto Co., Ltd. at 120° C.

### Dry Lamination

An adhesive for dry lamination (“TAKENATE A-520/A-50” manufactured by Takeda Chemical Industries, Ltd.; two component, urethane adhesive) of ethylacetate solution was applied onto a non-orientated polypropylene film (CPP, RXC-18 produced by Mitsui Tohcello, Thickness 60 μm), followed by evaporation of the solvent at 80° C. Then, the obtained multilayer film or oriented multilayer film was laminated to the CPP film by using laminator (DX-350 manufactured by TOLAMI), whereby a laminate was obtained. Aging was carried out at 40° C. for 4 days. Thus, A multilayer film having a structure of PA/“EVOH+PA”/PA/adhesive/CPP and oriented PA/“EVOH+PA”/PA/adhesive/CPP were obtained.

### Retort Treatment

The multilayer film was cut into square pieces having a 12 cm by 12 cm dimension. Two pieces were laid over facing CPP layer and the CPP layer each other. Then, three sides of the pieces were heat-sealed to produce a bag. Thereafter, 80 mL of deionized water was filled in the bag. The remained one side was sealed with heat sealer to obtain water filled pouch. The water filled pouch composed by the multilayer film was subjected to a hot water treatment at 120° C. for 45 min using a high-temperature and high-pressure retort sterilization machine (RCS-60/10RSPXG-FAM manufactured by Hisaka Works, LTD). After the hot water treatment, the multilayer film was stored in a room at 20° C. and 65% RH for 1 hour, and the appearance of the multilayer film was visually observed and evaluated according to the following criteria.

A: No whitening

B: Slight whitening at some parts

C: Whitening at most of parts

### Materials

EVOH A-1: EVAL™ LI71B, commercially available from Kuraray Co., Ltd. (ethylene content 27 mol %, a degree of saponification 99.9 mol %, MFR of 4.0 g/10 minutes (210° C., 2,160 g)).

EVOH A-2: EVAL™ F171B, commercially available from Kuraray Co., Ltd. (ethylene content 32 mol %, degree of saponification 99.9 mol ° %, MFR of 1.6 g/10 minutes (190° C., 2,160 g)).

EVOH A-3: EVAL™ LV101B, commercially available from Kuraray Co., Ltd. (ethylene content 27 mol %, a degree of saponification 99.9 mol %, MFR of 3.2 g/10 minutes (210° C., 2,160 g)).

PA B-1: SF1018A nylon 6, commercially available from UBE Industries, Ltd.

Fatty Acid Metal Salt C-1: magnesium stearate.

Fatty Acid Metal Salt C-2: 20 wt % Mg acetate water solution (0.1 parts by mass as Mg acetate).

### Example 1

90 parts by mass of EVOH A-1, 10 parts by mass of PA B-1 and 0.44 parts by mass of fatty acid metal salt C-1 were blended. The resulting blend was subjected to melt compounding, pelletizing and drying under the following conditions, and then the resin composition was obtained.

Apparatus: 30 mmD twin screw extruder (TEX-30a manufactured by The Japan Steel Works, Ltd.)

L/D: 45 Screw: co-rotating full-intermeshing type

Number of die holes: 4 holes (3 mmD)

Extrusion temperature (° C.): C2-C4=50, C5=60, C6=80, C7=90 C8=150, C9=190, C10−13=230, Die=230

Rotation speed: 150 rpm

Output: about 20 kg/hr

Drying: hot air drying at 80° C. for 6 hr

The amount of magnesium element in the resin composition was analyzed by ICP according to the method described above. The amount of fatty acid metal salt was calculated from contents of Mg element in the resin composition. The results are shown in Table 1.

MFR and MFR at 40 min/MFR at 20 min of the resin composition were evaluated as described above. The results are summarized in Table 2.

Long run stability of the resin composition at film making process was evaluated by employing 20 mm single screw extruder as above mentioned condition. The results are shown in Table 2.

Oxygen permeability of the obtained monolayer film was evaluated above mentioned method and shown in Table 2.

A multilayer article having PA/“EVOH+PA”/PA (15 μm/15 μm/15 μm) layer structure was prepared by cast co-extrusion method described above. The obtained PA/“EVOH+PA”/PA multilayer article was oriented by above mentioned method. Multilayer film having PA/“EVOH+PA”/PA/Adhesive/CCP and oriented-PA/“EVOH+PA”/PA/Adhesive/CCP layer structure were prepared by dry lamination as above. The retort resistance and retort resistance after orientation were evaluated and the results are summarized in Table 2.

### Example 2

Example 1 was repeated, except that EVOH A-2 was used in place of A-1.

The composition is shown in Table 1, and the test results are shown in Table 2.

### Example 3

Example 1 was repeated except that 0.38 parts by mass of fatty acid metal salt C-1 was used.

The composition is shown in Table 1, and the test results are shown in Table 2.

### Example 4

Example 1 was repeated, except that 0.50 parts by mass of fatty acid metal salt C-1 was used.

The composition is shown in Table 1, and the test results are shown in Table 2.

### Example 5

Example 1 was repeated except that 0.26 parts by mass of fatty acid metal salt C-1 was used.

The composition is shown in Table 1, and the test results are shown in Table 2.

### Example 6

Example 1 was repeated except that 0.58 parts by mass of fatty acid metal salt C-1 was used.

The composition is shown in Table 1, and the test results are shown in Table 2.

### Example 7

Example 1 was repeated except that 95 parts by mass of EVOH A-1 and 5 parts by mass of PA B-1 were used.

The composition is shown in Table 1, and the test results are shown in Table 2.

### Example 8

Example 1 was repeated except that 85 parts by mass of EVOH A-1 and 15 parts by mass of PA B-1 were used.

The composition is shown in Table 1, and the test results are shown in Table 2.

### Example 9

Example 1 was repeated except that 80 parts by mass of EVOH A-1 and 20 parts by mass of PA B-1 were used.

The composition is shown in Table 1, and the test results are shown in Table 2.

### Comparative Example 1

Example 1 was repeated except that a fatty acid metal salt was not used.

The composition is shown in Table 1, and the test results are shown in Table 2.

### Comparative Example 2

Example 1 was repeated except that 0.22 parts by mass of fatty acid metal salt C-1 was used.

The composition is shown in Table 1, and the test results are shown in Table 2.

### Comparative Example 3

Example 1 was repeated except that 0.66 parts by mass of fatty acid metal salt C-1 was used.

The composition is shown in Table 1, and the test results are shown in Table 2.

### Comparative Example 4

Example 1 was repeated except that EVOH A-3 was used in place of A-1.

The composition is shown in Table 1, and the test results are shown in Table 2.

### Comparative Example 5

Example 1 was repeated except that 98 parts by mass of EVOH A-1 and 2 parts by mass of PA B-1 were used.

The composition is shown in Table 1, and the test results are shown in Table 2.

### Comparative Example 6

Example 1 was repeated except that 75 parts by mass of EVOH A-1 and 25 parts by mass of PA B-1 were used.

The composition is shown in Table 1, and the test results are shown in Table 2.

### Comparative Example 7

90 parts by mass of EVOH A-1 and 10 parts by mass of PA B-1 were blended. The resulting blend was subjected to melt compounding, pelletizing under following conditions. 0.10 parts by mass of 20 wt % Mg acetate water solution (0.02 parts by mass as Mg acetate) was injected at zone 6 of extruder by using metering pump manufactured by Fuji Techno Industries Corporation. Water was removed at Zone 9 from vacuum vent. The obtained pellet was dried under the following condition, and then the resin composition was obtained.

Apparatus: 30 mmD twin screw extruder (TEX-30a manufactured by The Japan Steel Works, Ltd.)

L/D: 45 Screw: co-rotating full-intermeshing type

Number of die holes: 4 holes (3 mmD)

Extrusion temperature (° C.): C2-C4=50, C5=60, C6=80, C7=90 C8=150, C9=190, C10-13=230, Die=230

Rotation speed: 150 rpm

Output: about 20 kg/hr

Drying: hot air drying at 80° C. for 6 hr

The composition is shown in Table 1, and the test results are shown in Table 2.

### Comparative Example 8

Comparative Example 7 was repeated except that 0.10 parts by mass of fatty acid metal salt C-2 was used.

The composition is shown in Table 1, and the test results are shown in Table 2.

TABLE 1

| | EVOH | | Polyamide | | Fatty Acid Metal Salt | | | |
|---|---|---|---|---|---|---|---|---|
| | | Parts by Mass | | Parts by Mass | | Parts by Mass | Parts by Mass | ppm as of Metal |
| EX. | Type | (Charged) | Type | (Charged) | Type | (Charged) | (Measured) | (Measured) |
| 1 | A-1 | 90 | B-1 | 10 | C-1 | 0.44 | 0.44 | 181 |
| 2 | A-2 | 90 | B-1 | 10 | C-1 | 0.44 | 0.43 | 177 |
| 3 | A-1 | 90 | B-1 | 10 | C-1 | 0.38 | 0.37 | 153 |
| 4 | A-1 | 90 | B-1 | 10 | C-1 | 0.50 | 0.50 | 206 |
| 5 | A-1 | 90 | B-1 | 10 | C-1 | 0.26 | 0.27 | 113 |
| 6 | A-1 | 90 | B-1 | 10 | C-1 | 0.58 | 0.58 | 238 |
| 7 | A-1 | 95 | B-1 | 5 | C-1 | 0.44 | 0.43 | 177 |
| 8 | A-1 | 85 | B-1 | 15 | C-1 | 0.44 | 0.45 | 185 |
| 9 | A-1 | 80 | B-1 | 20 | C-1 | 0.44 | 0.44 | 181 |
| CE1 | A-1 | 90 | B-1 | 10 | — | — | — | — |
| CE2 | A-1 | 90 | B-1 | 10 | C-1 | 0.22 | 0.22 | 91 |
| CE3 | A-1 | 90 | B-1 | 10 | C-1 | 0.66 | 0.67 | 276 |
| CE4 | A-3 | 90 | B-1 | 10 | C-1 | 0.44 | 0.44 | 182 |
| CE5 | A-1 | 98 | B-1 | 2 | C-1 | 0.44 | 0.45 | 183 |
| CE6 | A-1 | 75 | B-1 | 25 | C-1 | 0.44 | 0.45 | 184 |
| CE7 | A-1 | 90 | B-1 | 10 | C-2 | 0.02 | 0.02 | 41 |
| CE8 | A-1 | 90 | B-1 | 10 | C-2 | 0.10 | 0.11 | 182 |

TABLE 2

| | | MFR at 40 min/MFR | | | | Retort |
|---|---|---|---|---|---|---|
| | MFR at 6 min | at 20 min | Long run | | Retort | resistance |
| | (230° C./2160 g) | (230° C./2160 g) | stability | Oxygen permeability | resistance | after orientation |
| EX. | (g/10 min) | (—) | A > B > C > D | (cc · 20 μm/m2 · day · atm) | A > B > C | A > B > C |
| 1 | 8.1 | 1.5 | A | 0.3 | A | A |
| 2 | 8.2 | 1.6 | A | 0.5 | A | A |
| 3 | 7.8 | 2.3 | A | 0.3 | A | A |
| 4 | 7.8 | 1.3 | A | 0.3 | A | A |
| 5 | 8.2 | 1.1 | B | 0.3 | A | B |
| 6 | 8.4 | 1.1 | B | 0.3 | A | A |
| 7 | 8.6 | 1.8 | A | 0.2 | B | B |
| 8 | 7.4 | 1.2 | B | 0.6 | A | A |
| 9 | 7.0 | 1.1 | B | 1.0 | A | A |
| CE1 | 7.0 | 0.1 | D | 0.3 | A | C |
| CE2 | 8.0 | 0.8 | C | 0.3 | A | B |
| CE3 | 8.4 | 0.8 | C | 0.3 | A | A |
| CE4 | 8.4 | 0.7 | C | 0.3 | A | A |
| CE5 | 8.8 | 2.0 | A | 0.2 | C | C |
| CE6 | 6.8 | 0.7 | C | 1.5 | A | A |
| CE7 | 8.5 | 2.0 | A | 0.3 | A | C |
| CE8 | 8.8 | 6.8 | D | 0.3 | A | C |

As shown in Table 2, Example 1 to 9 showed good long run stability during film making process. The monolayer film prepared from these resin compositions showed excellent oxygen permeability. The multilayer film prepared from these resin compositions showed excellent retort resistance even after orientation.

On the other hand, Comparative Example 1 which did not have a fatty acid metal salt and higher MFR at 40 min than MFR at 20 min showed inferior long run stability to Examples.

Furthermore, Comparative Example 2 which had lower fatty acid metal salt content than Examples and did not have higher MFR at 40 min than MFR at 20 min showed inferior long run stability to Examples.

Comparative Example 3, which had higher fatty acid metal salt content than inventive Examples, did not have higher MFR at 40 min than MFR at 20 min showed inferior long run stability to Examples.

Comparative Example 4 which did not have higher MFR at 40 min than MFR at 20 min with inappropriate EVOH grade showed inferior long run stability to Examples.

Comparative Example 5 which had lower polyamide content than Examples showed inferior retort resistance to Examples.

Comparative Example 6 which had higher polyamide content than the inventive Examples did not have higher MFR at 40 min than MFR at 20 min showed inferior long run stability and oxygen permeability to Examples.

Comparative Example 7 and 8 which had a lower fatty acid metal salt instead of a higher fatty acid metal salt showed inferior retort resistance after orientation.

### INDUSTRIAL APPLICABILITY

The resin composition according to the embodiment of the present invention can show good thermal stability during melt processing. The multilayer film or sheet according to the embodiment of the present invention exhibits superior oxygen permeability, retort resistance and retort resistance after orientation. The container according to the embodiment of the present invention exhibits superior oxygen permeability, retort resistance and retort resistance after orientation. The packaging material according to the embodiment of the present invention exhibits superior oxygen permeability, retort resistance and retort resistance after orientation. Therefore, the resin composition, the multilayer film or sheet, the container and the packaging material are suitable for use in boiling sterilization, retort sterilization, or the like.

1. A resin composition comprising:
(A) an ethylene-vinyl alcohol copolymer having an ethylene content of from about 20 mol % to about 60 mol %;
(B) a polyamide; and
(C) a higher fatty acid metal salt;
wherein:
(i) the mass ratio (A/B) of the ethylene-vinyl alcohol copolymer (A) to the polyamide (B) is from about 80/20 to about 95/5,
(ii) the content of the fatty acid metal salt (C) with respect to a resin content (A+B) in terms of metal element equivalent is from about 100 ppm to about 250 ppm, and
(iii) the resin composition has higher melt flow rate (MFR) at 40 min holding than 20 min holding measured at 230° C.

2. The resin composition of claim 1, wherein the ethylene-vinyl alcohol copolymer (A) has a degree of saponification of about 99 mol % or greater.

3. The resin composition of claim 1, wherein the metal element of the higher fatty acid metal salt is selected from the group consisting of magnesium, calcium zinc or a combination thereof.

4. The resin composition of claim 3, wherein the higher fatty acid of the higher fatty acid metal salt give a carboxylic acid anion having 12 to 26 carbon atoms.

5. The resin composition of claim 4, wherein the higher fatty acid metal salt is Mg stearate.

6. The resin composition of claim 1, wherein the resin composition has from about 1.1 times to about 3 times higher melt flow rate (MFR) at 40 min holding than at 20 min holding measured at 230° C.

7. The resin composition of claim 1, containing about 1000 ppm or less total of alkali metal and alkaline earth metal in terms of metal element equivalent.

8. The resin composition of claim 7, containing about 750 ppm or less total of alkali metal and alkaline earth metal in terms of metal element equivalent.

9. The resin composition of claim 8, containing about 500 ppm or less total of alkali metal and alkaline earth metal in terms of metal element equivalent.

10. The resin composition of claim 1, wherein the ethylene-vinyl alcohol copolymer (A) has a degree of saponification of about 99 mol % or greater; the higher fatty acid metal salt is Mg stearate; and containing about 1000 ppm or less total of alkali metal and alkaline earth metal in terms of metal element equivalent.

11. A multilayer film or sheet including a barrier layer formed from a resin composition comprising:
(A) an ethylene-vinyl alcohol copolymer having an ethylene content of from about 20 mol % to about 60 mol %;
(B) a polyamide; and
(C) a higher fatty acid metal salt;
wherein:
(i) the mass ratio (A/B) of the ethylene-vinyl alcohol copolymer (A) to the polyamide (B) is from about 80/20 to about 95/5,
(ii) the content of the fatty acid metal salt (C) with respect to a resin content (A+B) in terms of metal element equivalent is from about 100 ppm to about 250 ppm, and
(iii) the resin composition has higher melt flow rate (MFR) at 40 min holding than 20 min holding measured at 230° C.

12. The multilayer film or sheet of claim 11, further comprising a polyamide layer.

13. The multilayer film or sheet of claim 11, wherein the ethylene-vinyl alcohol copolymer (A) has a degree of saponification of about 99 mol % or greater.

14. The multilayer film or sheet of claim 11, wherein the metal element of the higher fatty acid metal salt is selected from the group consisting of magnesium, calcium zinc or a combination thereof.

15. The multilayer film or sheet of claim 14, wherein the higher fatty acid of the higher fatty acid metal salt give a carboxylic acid anion having 12 to 26 carbon atoms.

16. The multilayer film or sheet of claim 15, wherein the higher fatty acid metal salt is Mg stearate.

17. The multilayer film or sheet of claim 11, wherein the resin composition has from about 1.1 times to about 3 times higher melt flow rate (MFR) at 40 min holding than at 20 min holding measured at 230° C.

18. The multilayer film or sheet of claim 11, containing about 1000 ppm or less total of alkali metal and alkaline earth metal in terms of metal element equivalent.

19. The multilayer film or sheet of claim 11, wherein the ethylene-vinyl alcohol copolymer (A) has a degree of saponification of about 99 mol % or greater; the higher fatty acid metal salt is Mg stearate; and containing about 1000 ppm or less total of alkali metal and alkaline earth metal in terms of metal element equivalent.

20. A packaging material comprising a multilayer film or sheet including a barrier layer formed from a resin composition comprising:
(A) an ethylene-vinyl alcohol copolymer having an ethylene content of from about 20 mol % to about 60 mol %;
(B) a polyamide; and
(C) a higher fatty acid metal salt;
wherein:
(i) the mass ratio (A/B) of the ethylene-vinyl alcohol copolymer (A) to the polyamide (B) is from about 80/20 to about 95/5,
(ii) the content of the fatty acid metal salt (C) with respect to a resin content (A+B) in terms of metal element equivalent is from about 100 ppm to about 250 ppm, and
(iii) the resin composition has higher melt flow rate (MFR) at 40 min holding than 20 min holding measured at 230° C.

21. The packaging material of claim 20, wherein the multilayer film or sheet further comprises a polyamide layer.
